(19) United States
(12) Patent Application Publication
(10) Pub. No.: US 2016/0063951 A1
(43) Pub. Date: Mar. 3, 2016

(54) ENVIRONMENTALLY ADAPTIVE DISPLAY ADJUSTMENT

(71) Applicant: QUALCOMM Incorporated, San Diego, CA (US)

(72) Inventors: Ike Ikizyan, San Diego, CA (US); Min Dai, San Diego, CA (US)

(21) Appl. No.: 14/469,080

(22) Filed: Aug. 26, 2014

(51) Int. Cl. G09G 5/02

(52) U.S. Cl. CPC G09G 5/02; G09G 2340/06; G09G 2320/0666

(57) ABSTRACT

A device includes a memory and at least one processor coupled to the memory. The at least one processor is configured to: generate, an original image for display, store the original image in the memory, adjust color tone of the original image by suppressing blue energy of a color spectrum of the original image to produce an adjusted image, store the adjusted image in the memory, and output the adjusted image for display.

### TECHNICAL FIELD

This disclosure relates to techniques for outputting images for display by a computing device.

### BACKGROUND

Smartphones and other electronic devices have displays that may output significant amounts of blue wavelength light.

### SUMMARY

In one example, a method includes generating, by a computing device and for display, an original image, adjusting, by the computing device, a color tone of the original image by suppressing blue energy of a color spectrum of the original image to produce an adjusted image, and outputting, by the computing device and for display, the adjusted image.

In another example, a computing device includes a memory and at least one processor coupled to the memory. The at least one processor is configured to: generate, an original image for display, store the original image in the memory, and adjust color tone of the original image by suppressing blue energy of a color spectrum of the original image to produce an adjusted image. The at least one processor is further configured to store the adjusted image in the memory, and output the adjusted image for display.

In another example, a computing device includes means for generating, by a computing device and for display, an original image, means for adjusting, by the computing device, a color tone of the original image by suppressing blue energy of a color spectrum of the original image to produce an adjusted image, and means for outputting, by the computing device and for display, the adjusted image.

In an additional example, a non-transitory computer-readable storage medium storing instructions that, when executed, cause at least one processor to: generate, by a computing device and for display, an original image, adjust, by the computing device, color tone of the original image by suppressing blue energy of a color spectrum of the image to produce an adjusted image, and output, by the computing device and for display, the adjusted image.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system for adjusting the color tone of an image for display at a computing device, in accordance with one or more techniques of the present disclosure.

FIG. 2 is a block diagram illustrating further details of the example system for adjusting the color tone of an image for display at a computing device, in accordance with one or more techniques of the present disclosure.

FIG. 3 is a flow diagram illustrating example operations of a computing device configured to adjust the color tone of an image for display at a computing device, in accordance with one or more techniques of the present disclosure.

### DETAILED DESCRIPTION

This disclosure describes a computing device configured to adjust the color tone of an image to produce an adjusted image. The computing device is further configured to output the adjusted image for display. The computing device may adjust the color tone of the original image by suppressing blue energy of a color spectrum of the original image. For example, the computing device may be configured to suppress the blue energy of the color spectrum of the original image such that the adjusted image reduces eyestrain and/or harmonizes with the color tone of external surroundings relative to the computing device.

Color tone may be relatively “warm” or “cool.” Warm color tone refers to yellowish white through red colors, and cool color tone refers to bluish white colors. Many displays used in conjunction with computing devices, such as smart phones, tablets, laptops, desktops, etc., produce relatively large percentages of blue (cool) wavelength light relative to other wavelengths of light. The human eye is particularly sensitive to blue wavelength light, i.e. light having a wavelength typically in the range of 400-500 nanometers (nm), but possibly as high as 530 nm.

In an outdoor setting, the amount of blue wavelength light in the color spectrum emitted by the sun may decrease during the evening hours as the sun goes down or around a user's bedtime. However, a display of a computing device generally does not reduce the amount of blue wavelength that such displays emit during night time or at a user's bedtime. The blue light that the display emits may interfere with a user of the display's ability to fall asleep. Techniques of this disclosure may thus improve a user of a display's ability to fall asleep by reducing blue wavelength light that the display emits, i.e. by warming the color tone of an image.

A user of a computing device may also prefer to view images that are harmonious with the external surroundings of the computing device. The external surroundings may include external light relative to the computing device or whether it is daytime or nighttime where the computing device is located. As an example, at night time, or at a user's bedtime, a user may prefer to view images that are not as bright. In bright sunlight however, a user may have difficulty viewing darker images. Increasing the brightness of an image may enhance image visibility during these times. A computing device configured in accordance with the techniques of this disclosure may be configured to adjust the color spectrum of an image based on external surroundings to improve subjective quality of the image. The computing device may adjust the color spectrum of an image for display by harmonizing the color spectrum of the image with a color spectrum of the external surroundings of the computing device. A computing device configured in accordance with the techniques of this disclosure may also adjust images for display output based on external surroundings to increase viewing comfort, by potentially reduce eye strain of a user of the device.

In one example, this disclosure describes a computing device configured to perform display adjustment techniques that may be implemented in hardware and/or software. A computing device configured in accordance with the techniques of this disclosure may determine how and when to adjust a transmitted light color spectrum of a display and/or color tone of the display content based on factors such as: a time of day, geographic location, light information detected by an ambient light sensor of the computing device, and light information determined by a camera of the computing device, as some examples. The inputs may further include information estimated user activity information such as: a user's bedtime, which the computing device may determine based on activity of the computing device, information from a user's calendar accessible by the computing device, and GPS data related to a user's commute, as some examples.

Based on the inputs, the display adjustment algorithm may modify various properties of the display, including: color warmth, backlight brightness, and pixel intensity(ies), and may use color management to adjust specific colors of the display. When adjusting the display output, the adjustment algorithm may typically reduce the energy of blue of a color spectrum of an image having wavelengths in the range of 400-500 nanometers.

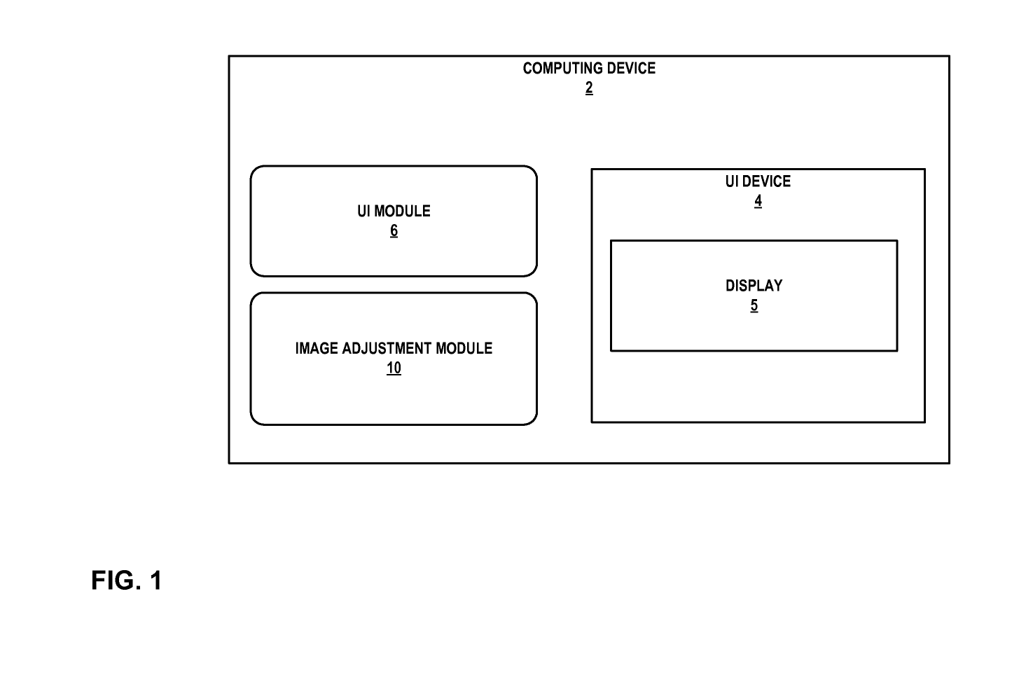

FIG. 1 is a block diagram illustrating an example system for adjusting the color tone of an image for display at a computing device, in accordance with one or more techniques of the present disclosure. As shown in the example of FIG. 1, the system includes computing device 2. In the example of FIG. 1, computing device 2 includes user interface (“UI”) device 4, user interface (“UI”) module 6, display 5, and image adjustment module 10.

Examples of computing device 2 may include, but are not limited to, portable or mobile devices such as mobile phones (including smart phones), tablet computers, laptop computers, cameras, personal digital assistants (PDAs), gaming systems, media players, e-book readers, television platforms, or any other electronic device that includes a display. Some examples of computing device 2 that implement techniques of this disclosure may include additional components not shown in FIG. 1.

UI device 4 of computing device 2 may function as respective input and/or output devices for computing device 2. UI device 4 may include display 5. A user associated with computing device 2 may interact with computing device 2 by providing various user inputs into the computing device 2, e.g., using the at least one UI device 4. UI device 4 may be implemented using various technologies. For instance, UI device 4 may function as an input device using a presence-sensitive input screen, such as a resistive touchscreen, a surface acoustic wave touchscreen, a capacitive touchscreen, a projective capacitance touchscreen, a pressure sensitive screen, an acoustic pulse recognition touchscreen, or another presence-sensitive display technology. Display 5 may function as an output using any one or more display devices, such as liquid crystal displays (LCD), dot matrix displays, light emitting diode (LED) displays, organic light-emitting diode (OLED) displays, or color displays capable of outputting visible information to a user of computing device 2. In some examples, the display devices can be physically separate from a presence-sensitive device included in computing device 2.

UI device 4 may include a presence-sensitive display that may receive tactile input from a user of computing device 2. UI device 4 may receive indications of tactile input by detecting one or more gestures from a user (e.g., the user touching or pointing to one or more locations of UI device 4 with a finger or a stylus pen). UI device 4 may present output to a user, for instance at respective presence-sensitive displays. Display 5 may present the output as respective graphical user interfaces, which may be associated with functionality provided by computing device 2. For example, Display 5 may present various user interfaces related to the functionality of computing platforms, operating systems, applications, and/or services executing at or accessible by computing device 2 (e.g., electronic message applications, Internet browser applications, mobile or desktop operating systems, etc.). A user may interact with a user interface to cause computing device 2 to perform respective operations relating to functions.

Computing device 2 may also include a user interface (“UI”) module 6, and image adjustment module 10. UI module 6 can perform one or more functions to receive an indication of input, such as user input, and send the indications of the input to other components associated with computing device 2. UI module 6 may receive indications of user input from various sources, such as UI device 4, a network interface, or a user input device. Using the data, UI module 6 may cause other components associated with computing device 2, such as UI device 4, to provide output based on the data.

GPU 12 may generate a first, original image for output, e.g. at display 5. Image adjustment module 10 may determine adjustments to the image to produce an adjusted image for output at display 5. Image adjustment module 10 may also signal commands and/or instructions to GPU 12 that indicate how GPU 12 is to modify the original image. Image adjustment module 10 may signal GPU 12 to adjust the image such that the adjusted image reduces the blue wavelength energy of the original image. The adjusted image may reduce user eye strain and/or harmonize the adjusted image with external surroundings of computing device 2.

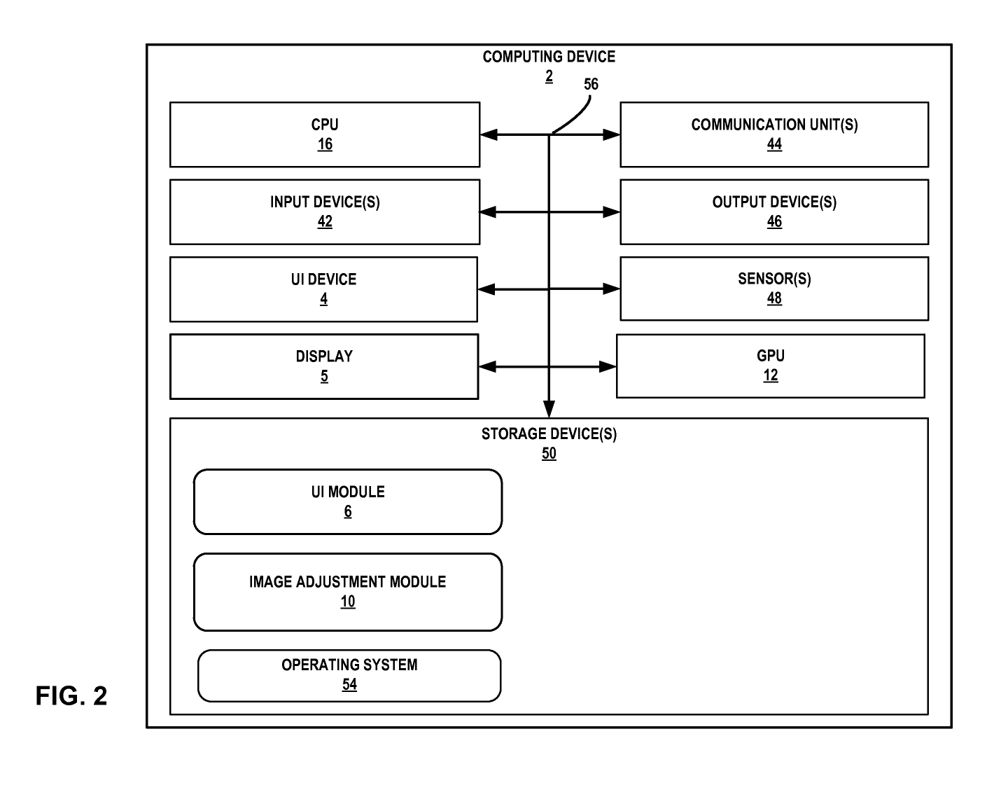

Image adjustment module 10 may adjust an original image to harmonize with the external surroundings of computing device 2 based on a number of factors. For example, image adjustment module 10 may receive ambient light information from one or more sensors of computing device 2 (e.g., one of sensors 48 of FIG. 2). Image adjustment module 10 may adjust the original image based on the received ambient light information. Such sensors may include a camera, or an ambient light sensor, as non-limiting examples. The ambient light information may include a brightness value, and/or color information about the ambient light relative to computing device 2. Color information may include red, green, and blue color channel information, as well as color tone of the ambient light as some examples.

In some examples, image adjustment module 10 may determine how to adjust an original image based on contextual data such as the time of day, the position or location of the device, global positioning system (GPS) data, device activity logs, weather conditions, and/or user input activity. Additional examples of adjusting image to reduce blue light energy and/or to harmonize an image for output are described in greater detail with respect to FIG. 2, below.

Modules 6 and 10 may perform operations described using software, hardware, firmware, or a mixture of hardware, software, and firmware residing in and/or executing at respective computing device 2. Computing device 2 may each execute respective modules 6 and 10 with one or more processors, such as CPU 16 and GPU 12. Computing device 2 may execute respective modules 6 and 10 as one or more virtual machines executing on underlying hardware of computing device 2. Modules 6 and 10 may execute as one or more services or components of operating systems or computing platforms of computing device 2. Modules 6 and 10 may execute as one or more executable programs at application layers of computing platforms of computing device 2. UID 4 and modules 6 and 10 may be otherwise arranged remotely to and remotely accessible to respective computing device 2, for instance, as one or more network services operating in a network cloud.

In this manner, computing device 2 represents an example of a computing device that may be configured to: generate, an original image for display, store the original image in a memory, adjust color tone of the original image by suppressing blue energy of a color spectrum of the original image to produce an adjusted image, store the adjusted image in the memory, and output the adjusted image for display.

FIG. 2 is a block diagram illustrating further details of an example system for adjusting the color tone of an image for display at a computing device, in accordance with one or more techniques of the present disclosure. FIG. 2 illustrates only one particular example of computing device 2. Many other examples of computing device 2 may be used in other instances.

As shown in the example of FIG. 2, computing device 2 includes UI device 4, GPU 12, CPU 16, one or more input devices 42, one or more communication units 44, one or more output devices 46, one or more sensors 48, and one or more storage devices 50. In the example of FIG. 2, computing device 2 further includes UI module 6, image adjustment module 10, and operating system 54, which are executable by CPU 16 and/or GPU 12. Each of components 4, 42, 44, 46, 48, and 50 may be coupled (physically, communicatively, and/or operatively) using communications channels 56 for inter-component communications. In some examples, communication channels 56 may include a system bus, a network connection, an inter-process communication data structure, or any other method for communicating data. UI module 6, image adjustment module 10, and operating system 54 may also communicate information with one another, as well as with other components in computing device 2.

CPU 16 may execute various types of applications on computing device 2. Examples of the applications include operating systems, web browsers, e-mail applications, spreadsheets, video games, or other applications that generate viewable objects for display. Instructions for execution of the one or more applications may be stored within system memory 14. CPU 16 may transmit graphics data of the generated viewable objects to GPU 12 for further processing.

For example, GPU 12 may be specialized hardware that allows for massive parallel processing, which functions well for processing graphics data. In this way, CPU 16 offloads graphics processing that is better handled by GPU 12. CPU 16 may communicate with GPU 12 in accordance with a particular application processing interface (API). Examples of such APIs include the DirectX® API by Microsoft® and the OpenGL® by the Khronos group; however, aspects of this disclosure are not limited to the DirectX and the OpenGL APIs, and may be extended to other types of APIs that have been developed, are currently being developed, or are to be developed in the future.

In addition to defining the manner in which GPU 12 is to receive graphics data from CPU 16, the APIs may define a particular graphics processing pipeline that GPU 12 is to implement. In some examples, GPU 12 may be specialized hardware that includes integrated and/or discrete logic circuitry that provides GPU 12 with massive parallel processing capabilities suitable for graphics processing. In some instances, GPU 12 may also include general purpose processing, and may be referred to as a general purpose GPU (GPGPU).

CPU 16 and GPU 12, in one example, are configured to implement functionality and/or process instructions for execution within computing device 2. For example, CPU 16 and GPU 12 may be capable of processing instructions stored by storage device 50. Examples of CPU 16 and GPU 12 may include, any one or more of a microprocessor, a controller, a digital signal processor (DSP), an application specific integrated circuit (ASIC), a field-programmable gate array (FPGA), or equivalent discrete or integrated logic circuitry.

In some examples, GPU 12 may include dedicated image adjustment hardware. The image adjustment hardware may include dedicated registers for a hardware color transformation matrix. The color transformation matrix may use matrix multiplication to modify red, green, and blue of an original image, and produces a modified image based on the transformation matrix applied. Additionally, GPU 12 may include dedicated hardware to modify the intensity of pixel values having certain characteristics. As an example, the color management hardware may include registers that indicate a set of pixel values that have certain characteristics. The color management hardware may then modify the pixels having those certain characteristics. As another example, the color management hardware may include registers that specify regions of an image (e.g., pixel regions) that the color management hardware should modify. In still other examples, however, the color management may be performed partially or solely in software or firmware.

One or more storage devices 50 may be configured to store information within computing device 2 during operation. Storage devices 50, in some examples, include a computer-readable storage medium or computer-readable storage device. In some examples, storage devices 50 include a temporary memory, meaning that a primary purpose of storage device 50 is not long-term storage. Storage devices 50, in some examples, include a volatile memory, meaning that storage device 50 does not maintain stored contents when power is not provided to storage device 50. Examples of volatile memories include random access memories (RAM), dynamic random access memories (DRAM), static random access memories (SRAM), and other forms of volatile memories known in the art. In some examples, storage devices 50 are used to store program instructions for execution by processors 40. Storage devices 50, in some examples, are used by software or applications running on computing device 2 (e.g., image adjustment module 10) to temporarily store information during program execution.

In some examples, storage devices 50 may further include one or more storage device 50 configured for longer-term storage of information. In some examples, storage devices 50 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 2, in some examples, also includes one or more communication units 44. Computing device 2, in one example, utilizes communication unit 44 to communicate with external devices via one or more networks, such as one or more wireless networks. Communication unit 44 may be a network interface card, such as an Ethernet card, an optical transceiver, a radio frequency transceiver, or any other type of device that can send and receive information. Other examples of such network interfaces may include Bluetooth, 3G, and Wi-Fi radios computing devices as well as Universal Serial Bus (USB). In some examples, computing device 2 utilizes communication unit 44 to wirelessly communicate with an external device such as a server or a wearable computing device.

Computing device 2, in one example, also includes one or more input devices 42. Input devices 42, in some examples, is configured to receive input from a user through tactile, audio, or video sources. Examples of input devices 42 include a presence-sensitive device, such as a presence-sensitive display, a mouse, a keyboard, a voice responsive system, video camera, microphone or any other type of device for detecting a command from a user. In some examples, a presence-sensitive display includes a touch-sensitive display.

One or more output devices 46 may also be included in computing device 2. Output device 46, in some examples, is configured to provide output to a user using tactile, audio, or video stimuli. Output device 46, in one example, includes a presence-sensitive display, a sound card, a video graphics adapter card, or any other type of device for converting a signal into an appropriate form understandable to humans or machines. Additional examples of output device 46 include a speaker, a cathode ray tube (CRT) monitor, a liquid crystal display (LCD), light emitting diode (LED) display, plasma display, organic light emitting diode (OLED) display, or any other type of device that can generate intelligible output to a user. In some examples, UI device 4 may include functionality of one or more of input devices 42 and/or output devices 46.

Computing device 2 also can include UI device 4. In some examples, UI device 4 is configured to receive tactile, audio, or visual input. In addition to receiving input from a user, UI device 4 can be configured to output content such as a GUI for display at display device 5, such as a presence-sensitive display. In some examples, UI device 4 can include a presence-sensitive display that displays a GUI and receives input from a user using capacitive, inductive, and/or optical detection at or near the presence sensitive display. In some examples, UI device 4 is both one of input devices 44 and one of output devices 46.

In some examples, UI device 4 of computing device 2 may include functionality of input devices 42 and/or output devices 46. In some examples, a presence-sensitive device may detect an object at and/or near the presence-sensitive device. As one example range, a presence-sensitive device may detect an object, such as a finger or stylus, which is within two inches or less of the presence-sensitive device. The presence-sensitive device may determine a location (e.g., an (x,y,z) coordinate) of the presence-sensitive device at which the object was detected. In another example range, a presence-sensitive device may detect an object six inches or less from the presence-sensitive device. Other example ranges are also possible. The presence-sensitive device may determine the location of the device selected by the object using capacitive, inductive, and/or optical recognition techniques. In some examples, the presence-sensitive device provides output to a user using tactile, audio, or video stimuli as described with respect to output device 46.

Sensors 48 may be configured to determine a location of computing device 2, detect movement of computing device 2 and/or may collect other information associated with computing device 2. For instance, sensors 48 may be configured to measure the position, rotation, velocity, and/or acceleration of computing device 2. Examples of sensors 48 that detect and/or measure movement of computing device 2 may include, but are not limited to, accelerometers, gyroscopes, and compasses. Sensors 48 may also include a galvanic skin response sensor, a proximity sensor, and any other type of sensor capable of collecting information related to computing device 2.

Computing device 2 may include operating system 54. Operating system 54, in some examples, controls the operation of components of computing device 2. For example, operating system 54, in one example, facilitates the communication of UI module 6, communication module 8, image adjustment module 10, and context module 52 with CPU 16, GPU 12 communication units 44, storage devices 50, input devices 42, output devices 46, and sensors 48. UI module 6, communication module 8, image adjustment module 10, and context module 52 can each include program instructions and/or data that are executable by computing device 2 (e.g., by one or more processors 40). As one example, image adjustment module 10 can include instructions that cause computing device 2 to perform one or more of the operations and actions described in the present disclosure.

CPU 16 may execute UI module 6. UI module 6 may send commands and data to GPU 12 that cause GPU 12 to render an image for output at display 5. CPU 16 may also execute image adjustment module 10, and may send commands and data to GPU 12 that indicate that an image to be output at display 5 should be modified based on one or more factors in accordance with the techniques of this disclosure.

Image adjustment module 10 may instruct GPU 12 to suppress blue wavelength energy of an image for output at display 5 to produce a modified image in various examples. Blue wavelength energy of an image may include pixel data that, when output, has a wavelength of between 400-530 nm (nanometers). Image adjustment module 10 may instruct GPU 12 to adjust an original image to produce an adjusted image such that the adjusted image either reduces eye strain of a user of computing device 2 or harmonizes the image with external surroundings of the commuting device. Reducing the blue wavelength energy of an image for output may aid in reducing eye strain of a user of computing device 2, because blue wavelength light may be associated with eye strain.

To reduce the blue wavelength energy of an image, image adjustment module 10 may send instructions to GPU 12, which cause GPU 12 to modify pixel colors of an image for output at display 5. To modify the pixel colors of an image, GPU 12 may use a number of different techniques. As an example, GPU 12 may be configured to reduce blue wavelength energy of an image by reducing the intensity of a blue color channel for all pixels in an image. In some examples, GPU 12 may modify the blue channel intensity of pixels using a color transformation matrix to modify the intensity of pixel color channels of an image.

The color transformation matrix may comprise the following matrix of equation (1):

$$M = [ \begin{matrix}{m}_{00} & {m}_{01} & {m}_{02} \\ {m}_{10} & {m}_{11} & {m}_{12} \\ {m}_{20} & {m}_{21} & {m}_{22}\end{matrix} ] . \qquad ( 1 )$$

In general, GPU 12 may use the above color space conversion matrix to modify the blue wavelength energy of an RGB image according to the following equation (2), which uses the matrix of equation (1):

$$[ \begin{matrix}{R}_{out} \\ {G}_{out } \\ {B}_{out}\end{matrix} ] = M \cdot [ \begin{matrix}{R}_{in} \\ {G}_{in} \\ {B}_{in}\end{matrix} ] , \qquad ( 2 )$$

where
Rₒᵤₜ=m₀₀Rᵢₙ+m₀₁Gᵢₙ+m₀₂Bᵢₙ
Gₒᵤₜ=m₁₀Rᵢₙ+m₁₁Gᵢₙ+m₁₂Bᵢₙ
Bₒᵤₜ=m₂₀Rᵢₙ+m₂₁Gᵢₙ+m₂₂Bᵢₙ.
   For an RGB color space, GPU 12 may modify or reduce the blue energy of pixels of an image using the following matrix. In the preceding matrix, Rᵢₙ is a red color channel value of a pixel, Gᵢₙ is a green color channel value of a pixel, Bᵢₙ is a blue color channel value of a pixel, and M is a matrix consisting of nine multiplicative factors by which to multiply Rᵢₙ, Gᵢₙ, and Bᵢₙ. The result of the matrix multiplication is Rₒᵤₜ, the modified red channel pixel value, Gₒᵤₜ, the modified green channel pixel value, and Bₒᵤₜ, the modified blue channel pixel value.

In various examples, M may correspond to the following matrix of equation (3):

$${M}_{modified} = {M}_{original} \cdot [ \begin{matrix}1 & 0 & 0 \\ 0 & {α}_{G} & 0 \\ 0 & 0 & {α}_{B}\end{matrix} ] . \qquad ( 3 )$$

The matrix may contain parameters α_{G} and α_{B}. To reduce the blue wavelength energy, GPU 12 may set α_{B} to a value less than one. By modifying matrix coefficients, CPU 16 or GPU 12 may modify an original image to make the image appear warmer and to reduce blue wavelength energy of the image.

In some examples, GPU 12 may also be configured to reduce green wavelength energy of an image, as well as blue wavelength energy of an image. In this example, GPU 12 may set the value of α_{G} equal to a value less than one.

Image adjustment module 10 may also adjust an image for output such that the tone of the adjusted image harmonizes with a color tone of external surroundings relative to computing device 2. The external surroundings of computing device 2 may include properties of light that computing device 2 can detect. As an example, image adjustment module 10 may receive a brightness value of external light relative to computing device 2 from an ambient light sensor, which may comprise one of sensors 48.

The ambient light sensor may be a hardware ambient light sensor that detects an amount of light or color characteristics of light in the environment around computing device 2. In some examples, the ambient light sensor may include one or more of photoresistors, photocells, photodiodes, and/or phototransistors. In general, the ambient light sensor may be configured to imitate the sensitivity of a human eye over a visual spectral range of light having wavelengths of approximately 380 nm to approximately 780 nm. However, the ambient light sensor may be configured with different sensitivity and for different wavelengths of light. For example, the ambient light sensor may be configured to respond to infrared and/or ultraviolet light and may be configured to compensate for the detected infrared and/or ultraviolet light such that adjustments to the brightness level of a display made by image adjustment module 10 may be more accurate.

Based on a received brightness value, image adjustment module 10 may signal GPU 12 to adjust the color tone of an image for output at display 5 by reducing the blue wavelength energy of the image. As an example, if a received brightness value is low, the brightness value may indicate that computing device 2 is in a dark setting. Based on the determined low external light brightness value, image adjustment module 12 may reduce the blue wavelength energy of an image for output at display 5. Image adjustment module 10 may instruct GPU 12 to reduce the blue wavelength energy of an image inversely proportional to the external brightness value. Image adjustment module 10 may also increase the warmth of the outputted image. If image adjustment module 10 determines that computing device 2 is in a darkly-lit environment, image adjustment module 10 may also reduce a brightness of a backlight (i.e., a backlight level) of display 5 in some examples.

Image adjustment module 12 may also receive color spectrum data (e.g., color tone data) about external light relative to computing device 2 from one or more of sensors 48. In some examples, the ambient light sensor of sensors 48 may be configured to determine red, green, and blue color spectrum information of external light. In some examples, the camera of sensors 48 may be configured to determine color spectrum data and/or color tone data of external light. The camera may be configured to capture an image and apply a while balance function, such as a 3A function, to determine color tone of the captured image. A 3A function combines auto exposure, auto white balance, and auto focus functions of the camera to determine information about a captured image.

Image adjustment module 10 may modify the color spectrum and/or brightness of an image for output at display 5 based on the received external light color spectrum data and/or color tone data. As an example, the camera of image adjustment module 10 may receive external brightness data that indicates that the external light has low brightness values, which may indicate that computing device 2 is in a dark, poorly lit environment. Based on the low brightness of a color channel, image adjustment module 10 may adjust the color tone of an image by reducing blue wavelength energy of an image for output at display 5. The reduced blue wavelength energy may aid in reducing eye strain of a user of computing device 2.

In some examples, image adjustment module 10 may harmonize the color tone of an image for output at display 5 with the color spectrum of the external light based on received color spectrum data from sensors 48. As an example, a camera or ambient light sensor may determine color tone information of external light. Image adjustment module 10 may instruct GPU 12 to modify the color tone of an image for output to more closely match the color tone of the external light based on the received external light color tone information. Matching the color tone of an image for output with the color tone the external light may make the outputted image appear more pleasing to a user of mobile computing device 2.

Image adjustment module 10 may also instruct GPU 12 to modify the color tone of an image for output at display 5 based on geographic information associated with computing device 2. The geographic information may include GPS coordinates, which a GPS receiver and/or Wi-Fi transceiver of sensors 48 may determine. The geographic information may also include user-inputted location data, such as ZIP or postal code data, city and state information, time zone data, or any other type of user-inputted data that indicates the geographic location of computing device 2.

Image adjustment module 10 may determine a time at which to reduce the color tone of images for output at display 5 based on the geographic information. The geographic information may indicate a bedtime of a user of computing device 2, as an example. Image adjustment module 10 may calculate the bedtime of a user of computing device 2 based on a sunset time associated with the geographic location of computing device 2. As an example, image adjustment module 10 may calculate a user's bedtime by adding an amount of time to the sunset time associated with a geographic location. Image adjustment module 10 may add different time amounts to the sunset time based on the current calendar date. At the user's determined bedtime, image adjustment module 10 may signal GPU 12 to reduce blue wavelength energy of an image for output at display 5. In this manner, image adjustment module 10 may appropriately modify the user's bedtime based on account the geographic location, time of year, and other variables when modifying the color tone of an image in accordance with the techniques of this disclosure.

Image adjustment module 10 may reduce blue wavelength energy across all wavelengths of blue light (e.g., 400-500 nm wavelengths, 400-530 nm). Image adjustment module may determine a magnitude by which to reduce the blue wavelength energy based on a function, such as a on a mapping function. The mapping function may be a closed-form function, a LUT (lookup table), linear or non-linear function, as some non-limiting examples.

Image adjustment module 10 may reduce blue wavelength energy of an image for output at display 5 based on a determined commute time of a user of computing device 2 in some examples. Image adjustment module 10 may determine a commute time of a user based on data received from a GPS receiver of sensors 48. Image adjustment module may determine a typical commute pattern that occurs during a work week based on patterns in the GPS data. Image adjustment module 10 may determine a time that a user of computing device 2 commutes to work, and a time that the user returns home from work based on the pattern data. Based on the commute start and return times, image adjustment module 10 may calculate a user's estimated bedtime. Image adjustment module 10 may signal GPU 12 to adjust color tone of an image for output by reducing blue wavelength energy of an image at, or in advance of the calculated bedtime. Image adjustment module 10 may increase the reduction of blue wavelength energy of images for output as the user's bedtime approaches.

Image adjustment module 10 may reduce blue wavelength energy of an image for output at display 5 based on estimated activity of computing device 2 in some examples. Estimated activity may include phone calls made or received with computing device 2, and/or user input received with one of input devices 42. Based on the estimated activity, image adjustment module 10 may determine a bedtime for a user of computing device 2. In some examples, image adjustment module 10 may examine log data, e.g. stored on storage devices 50, to determine device activity.

As an example, image adjustment module 10 may determine that a user is sleeping during a period when a user consistently makes or receives no phone calls or other types of communications sessions (e.g., text messages, social network posts, video calls, VoIP calls, etc.). Image adjustment module 10 may also determine that a user is sleeping based on a period of user input inactivity in some examples. The period of inactivity may be a period during which input devices 42 receive no input from a user of computing device 2. Image adjustment module 10 may determine the user's bedtime based on the period during which mobile computing device 2 determines that the user is sleeping.

Image adjustment module 10 may determine when a user is at work based on calendar appointments stored on or accessible to computing device 2. Image adjustment module 10 may determine a user's bedtime based on when there are no more appointments in the user's calendar. Based on the determined bedtime, image adjustment module 10 may reduce blue wavelength energy of an image for output at display 5 in some examples.

In accordance with one or more aspects of this disclosure, image adjustment module 10 may be configured to: generate, an original image for display, store the original image in the memory, adjust color tone of the original image by suppressing blue energy of a color spectrum of the original image to produce an adjusted image, store the adjusted image in the memory, and output the adjusted image for display.

Computing device 2 can include additional components that, for clarity, are not shown in FIG. 2. For example, computing device 2 can include a battery to provide power to the components of computing device 2. Similarly, the components of computing device 2 shown in FIG. 2 may not be necessary in every example of computing device 2. For example, in some configurations, computing device 2 may not include output devices 46.

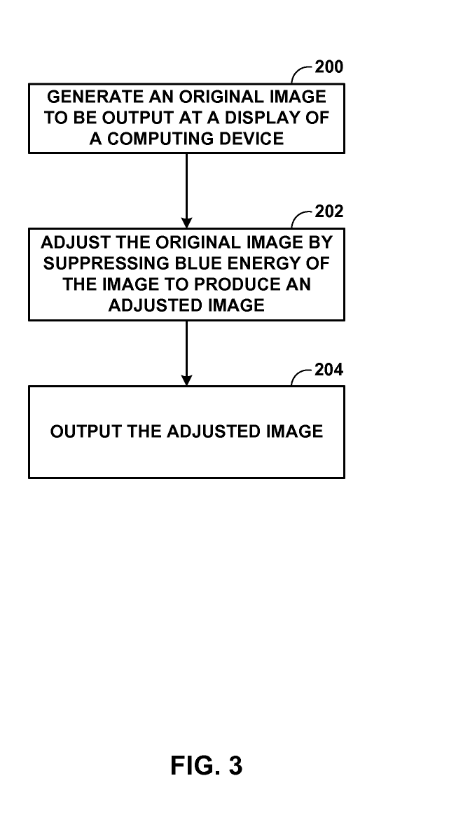

FIG. 3 is a flow diagram illustrating example operations of a computing device configured to adjusting the color tone of an image for display at a computing device, in accordance with one or more techniques of the present disclosure. The techniques of FIG. 3 may be performed by one or more processors of a computing device, such as computing device 2 illustrated in FIGS. 1 and 2. The processors may include GPU 12 and CPU 16. For purposes of illustration, the techniques of FIG. 3 are described within the context of computing device 2 of FIGS. 1 and 2, although computing devices having different configurations may perform the techniques of FIG. 3.

In accordance with one or more techniques of the disclosure, image adjustment module 10 of computing device 2 may generate and for display an original image (200). Image adjustment module 10 may further adjust color tone of the original image to produce an adjusted image (202). Image adjustment module 10 may adjust the original image to produce the adjusted image such that the adjusted image reduces eye strain of a user of the computing device or such that the adjusted image harmonizes the color spectrum of the adjusted image with a color spectrum of external surroundings relative to the computing device. Computing device 2 may output and for display, the adjusted image (204). In various examples, image adjustment module 10 may be further configured to reduce green energy of the original image color spectrum to produce the adjusted image.

In various examples, image adjustment module 10 may be configured to estimate activity of a user based on at least one of a group consisting of: device activity of the computing device, calendar information of the computing device, and GPS data of computing device 2. Image adjustment module 10 may be further configured to adjust the original image to produce the adjusted image based on the estimated activity of the user. The GPS data may indicate a commute time associated with the user of the computing device in some examples. The estimated activity may include at least one of a group consisting of: user input received by computing device 2 and a telephone call made or received with computing device 2 in some examples.

In some examples, an ambient light sensor of computing device 2 may determine a brightness value of the external light relative to computing device 2. Image adjustment module 10 may be further configured to adjust the color tone of the original image based on the brightness value to produce the adjusted image. In some examples, to adjust the color tone of the original image, image adjustment module 10 may be configured to warm the color tone of the original image if the brightness value from the ambient light sensor indicates that computing device 2 is in a darkly-lit environment. In some examples, image adjustment module 10 may determine the color tone of the external light using a 3A function. A 3A function may comprise an auto-focus function, an auto-exposure function, and an auto-white balance function.

In some examples, image adjustment module 10 may be further configured to: adjust the color tone of the original image based on at least one of a group consisting of: GPS coordinates, a geographic location, and a time of day associated with the computing device. In some examples, GPU 12 may be further configured to adjust, by color transformation hardware of GPU 12, a region of the original image having a color intensity within an intensity range. A register of the color transformation hardware may specify the region in some examples. To suppress the blue wavelength energy, image adjustment module 10 may be configured to suppress energy of the color spectrum of the original image in a range of 400 nm to 530 nm inclusive.

In some examples, to producing the adjusted image, image adjustment module 10 may be further configured to adjust a backlight level of display 5 to produce the adjusted image. To adjust the original image, image adjustment module 10 may be configured to adjust color channels of the original image using a color transformation matrix.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the invention have been described. These and other examples are within the scope of the following claims.

What is claimed is:

1. A method comprising:
generating, by a computing device and for display, an original image;
adjusting, by the computing device, a color tone of the original image by suppressing blue energy of a color spectrum of the original image to produce an adjusted image; and
outputting, by the computing device and for display, the adjusted image.

2. The method of claim 1, further comprising:
reducing, by the computing device, green energy of the original image color spectrum to produce the adjusted image.

3. The method of claim 1, further comprising:
estimating, by the computing device, activity of a user based on at least one of a group consisting of: device activity of the computing device, calendar information of the computing device, and GPS data of the computing device; and
adjusting, by the computing device, the original image to produce the adjusted image based on the estimated activity of the user.

4. The method of claim 3, wherein the GPS data indicates a commute time associated with a user of the computing device.

5. The method of claim 3, wherein the estimated activity includes at least one of a group consisting of: user input received by the computing device and a telephone call made or received with the computing device.

6. The method of claim 1, further comprising:
determining, by an ambient light sensor of the computing device, a brightness value of external light relative to the computing device; and
adjusting, by the computing device, the color tone of the original image based on the brightness value to produce the adjusted image.

7. The method of claim 6, wherein adjusting the color tone comprises warming the color tone of the original image if the brightness value indicates the computing device is in a darkly-lit environment.

8. The method of claim 1, further comprising:
determining, by a camera of the computing device, a color tone of external light relative to the computing device; and
adjusting, by the computing device, the color tone of the original image based on the color tone of the external light to produce the adjusted image.

9. The method of claim 8, wherein determining the color tone of the external light is determined using a 3A function, wherein the 3A function comprises:
an auto-focus function, an auto-exposure function, and an auto-white balance function.

10. The method of claim 1, further comprising:
adjusting, by the computing device, the color tone of the original image based on at least one of a group consisting of: global positioning system (GPS) coordinates, a geographic location, and a time of day associated with the computing device.

11. The method of claim 1, further comprising:
adjusting, by color transformation hardware of a GPU (graphics processing unit) of the computing device, a region of the original image having a color intensity within an intensity range, wherein a register of the color transformation hardware specifies the intensity range.

12. The method of claim 1, wherein adjusting the original image comprises:
adjusting, by the computing device, color channels of the original image using a color transformation matrix.

13. The method of claim 1, wherein producing the adjusted image further comprises:
adjusting, by the computing device, a backlight level of a display of the computing device to produce the adjusted image.

14. The method of claim 1, wherein suppressing the blue wavelength energy comprises suppressing energy of the color spectrum of the original image in a range of 400 nm to 530 nm (nanometers) inclusive.

15. A computing device comprising:
a memory; and
at least one processor coupled to the memory, wherein the at least one processor is configured to:
generate, an original image for display
store the original image in the memory;
adjust color tone of the original image by suppressing blue energy of a color spectrum of the original image to produce an adjusted image;
store the adjusted image in the memory; and
output the adjusted image for display.

16. The device of claim 15, wherein the at least one processor is further configured to: reduce green energy of the original image color spectrum to produce the adjusted image.

17. The device of claim 15, wherein the at least one processor is further configured to:
estimate activity of a user based on at least one of a group consisting of: device activity of the computing device, calendar information of the computing device, and GPS data of the computing device; and
adjust the original image to produce the adjusted image based on the estimated activity of the user.

18. The device of claim 17, wherein the GPS data indicates a commute time associated with the user of the computing device.

19. The device of claim 17, wherein the device activity includes at least one of a group consisting of: user input received by the computing device and a telephone call made or received with the computing device.

20. The device of claim 15, wherein the at least one processor is further configured to: determine, by an ambient light sensor of the computing device, a brightness value of external light relative to the computing device; and
adjust, by the computing device, the color tone of the original image based on the brightness value to produce the adjusted image.

21. The device of claim 20, wherein to adjust the color tone, the at least one processor is further configured to:
warm the color tone of the original image if the brightness value indicates the computing device is in a darkly-lit environment.

22. The device of claim 15, wherein the at least one processor is further configured to:
determine, by a camera of the computing device, a color tone of external light relative to the computing device; and
adjust, by the computing device, the color tone of the original image based on the color tone of the external light to produce the adjusted image.

23. The device of claim 22, wherein the color tone of the external light is determined using a 3A function, wherein the 3A function comprises:
an auto-focus function, an auto-exposure function, and an auto-white balance function.

24. The device of claim 15, wherein the at least one processor is further configured to:
adjust the color tone of the original image based on at least one of a group consisting of: global positioning system (GPS) coordinates, a geographic location, and a time of day associated with the computing device.

25. The device of claim 15, wherein the at least one processor comprises a graphics processing unit (GPU), wherein the GPU is further configured to:
adjust by color transformation hardware of the GPU, a region of the original image having a color intensity within an intensity range,
wherein a register of the color transformation hardware specifies the intensity range.

26. The device of claim 15, wherein to adjust the original image, the at least one processor is further configured to:
adjust color channels of the original image using a color transformation matrix.

27. The device of claim 15, wherein to produce the adjusted image, the at least one processor is configured to adjust a backlight level of a display of the computing device to produce the adjusted image.

28. The device of claim 15, wherein to suppress the blue wavelength energy, the at least one processor is configured to suppress energy of the color spectrum of the original image in a range of 400 nm to 530 nm (nanometers) inclusive.

29. A device comprising:
means for generating, by a computing device and for display, an original image;
means for adjusting, by the computing device, a color tone of the original image by suppressing blue energy of a color spectrum of the original image to produce an adjusted image; and
means for outputting, by the computing device and for display, the adjusted image.

30. A non-transitory computer-readable storage medium storing instructions that, when executed, cause one or more processors of a computing device to:
generate, by a computing device and for display, an original image;
adjust, by the computing device, color tone of the original image by suppressing blue energy of a color spectrum of the image to produce an adjusted image; and
output, by the computing device and for display, the adjusted image.
